(19) United States
(12) Patent Application Publication
(10) Pub. No.: US 2022/0270293 A1
(43) Pub. Date: Aug. 25, 2022

(54) CALIBRATION FOR SENSOR

(71) Applicant: Zhejiang Sense Time Technology Development Co., Ltd., Hangzhou (CN)

(72) Inventors: Hujun BAO, Hangzhou (CN); Guofeng ZHANG, Hangzhou (CN); Yuwei WANG, Hangzhou (CN); Yuqian LIU, Hangzhou (CN)

(21) Appl. No.: 17/740,679

(22) Filed: May 10, 2022

Related U.S. Application Data
(63) Continuation of application No. PCT/CN2020/128773, filed on Nov. 13, 2020.

(30) Foreign Application Priority Data
Nov. 19, 2019 (CN) 201911135984.3

(51) Int. Cl. G06T 7/80; G01S 13/06; G03B 13/30

(52) U.S. Cl. CPC G06T 7/80; G01S 13/06; G03B 13/30; G06T 2207/10028

(57) ABSTRACT

Methods, devices, systems, and computer-readable storage media for calibration of sensors are provided. In one aspect, a calibration method for a sensor includes: obtaining an image acquired by a camera of a sensor and obtaining radar point cloud data acquired by a radar of the sensor, a plurality of calibration plates being located within a common Field Of View (FOV) range of the camera and the radar and having different position-orientation information; for each of the plurality of calibration plates, detecting first coordinate points of the calibration plate in the image and second coordinate points of the calibration plate in the radar point cloud data; and calibrating an external parameter between the camera and the radar according to the first coordinate points and the second coordinate points of each of the plurality of calibration plates.

### CROSS REFERENCE TO RELATED APPLICATIONS

This application is a continuation application of International Application No. PCT/CN2020/128773 filed on Nov. 13, 2020, which claims priority to Chinese Patent Application No. 201911135984.3 filed on Nov. 19, 2019, the entire contents of which are incorporated herein by reference.

### TECHNICAL FIELD

Embodiments of the present disclosure relate to a calibration method and device for a sensor, and a system.

### BACKGROUND

With the continuous development of computer vision, in order to enable a device to better learn and perceive a surrounding environment, a multi-sensor fusion, for example, a fusion of a radar and a camera, is usually adopted. In a process of the fusion of the radar and the camera, an accuracy of an external parameter between the radar and the camera determines an accuracy of environment perception.

At present, a method of calibrating the external parameter between a radar and a camera is urgently needed to solve time-consuming and labor-intensive technical problems in a calibration process.

### SUMMARY

Embodiments of the present disclosure provide a calibration method and device for a sensor, and a system.

According to a first aspect of embodiments of the present disclosure, there is provided a calibration method for a sensor, including: obtaining an image acquired by a camera of the sensor and obtaining radar point cloud data acquired by a radar of the sensor, wherein a plurality of calibration plates are located within a common Field Of View (FOV) range of the camera and the radar, and have different position-orientation information; for each of the plurality of calibration plates, detecting first coordinate points of the calibration plate in the image and second coordinate points of the calibration plate in the radar point cloud data; and calibrating an external parameter between the camera and the radar according to the first coordinate points and the second coordinate points of each of the plurality of calibration plates.

According to a second aspect of embodiments of the present disclosure, there is provided a calibration device for a sensor, including: at least one processor; and at least one non-transitory memory coupled to the at least one processor and storing programming instructions for execution by the at least one processor to perform operations comprising: obtaining an image acquired by a camera of the sensor and obtaining radar point cloud data acquired by a radar of the sensor, wherein a plurality of calibration plates are located within a common Field Of View (FOV) range of the camera and the radar, and have different position-orientation information; for each of the plurality of calibration plates, detecting first coordinate points of the calibration plate in the image and second coordinate points of the calibration plate in the radar point cloud data; and calibrating an external parameter between the camera and the radar according to the first coordinate points and the second coordinate points of each of the plurality of calibration plates.

According to a third aspect of embodiments of the present disclosure, there is provided a system, including: a sensor including a camera and a radar; a plurality of calibration plates located within a common Field Of View (FOV) range of the camera and the radar, wherein the plurality of calibration plates have different position-orientation information; and a calibration device for calibrating the sensor, the calibration device comprising: at least one processor; and at least one non-transitory memory coupled to the at least one processor and storing programming instructions for execution by the at least one processor to: obtain an image acquired by the camera of the sensor and obtain radar point cloud data acquired by the radar of the sensor; for each of the plurality of calibration plates, detect first coordinate points of the calibration plate in the image and second coordinate points of the calibration plate in the radar point cloud data; and calibrate an external parameter between the camera and the radar according to the first coordinate points and the second coordinate points of each of the plurality of calibration plates.

The embodiments of the present disclosure provide a calibration method and device for a sensor, and a system, wherein the sensor includes a camera and a radar. The method includes: detecting first coordinate points of each calibration plate of a plurality of calibration plates in an image and second coordinate points of the calibration plate in radar point cloud data based on the image collected by the camera and the radar point cloud data collected by the radar, and then calibrating an external parameter between the camera and the radar based on the first coordinate points and the second coordinate points of each of the plurality of calibration plates, wherein the plurality of calibration plates are located within a common Field Of View (FOV) range of the camera and the radar, and the plurality of calibration plates have different position-orientation information.

Since the image and the radar point cloud data for calibration are respectively collected by the camera and the radar in such a scenario that a plurality of calibration plates with different position-orientation information are contained, a single image includes reflections of the plurality of calibration plates, and a set of radar point cloud data includes point cloud data corresponding to the plurality of calibration plates. Therefore, by collecting an image and a corresponding set of radar point cloud data, the external parameter between the camera and the radar can be calibrated, so that the number of images to be processed and the number of radar point cloud data to be processed can be effectively reduced while ensuring calibration accuracy, thereby saving resources occupied in data processing process.

In addition, in an image collection process of an actual calibration process, since the calibration plates are in a static state throughout the whole process, for the radar and the camera, the requirements for synchronization of the camera and the radar can be effectively reduced, thereby improving the calibration accuracy effectively.

### BRIEF DESCRIPTION OF THE DRAWINGS

FIG. 1 is a schematic diagram illustrating a calibration system according to an embodiment of the present disclosure.

FIG. 2 is a flowchart illustrating a calibration method for a sensor according to an embodiment of the present disclosure.

FIG. 3 is a schematic diagram illustrating position-orientations of a plurality of calibration plates in a camera coordinate system according to an embodiment of the present disclosure.

FIG. 4 is a schematic diagram illustrating a calibration system according to another embodiment of the present disclosure.

FIG. 5 is a flowchart illustrating corner point detection according to an embodiment of the present disclosure.

FIG. 6 is a schematic diagram illustrating spatial positions of corner points and projection points corresponding to each calibration plate before optimizing an external parameter according to an embodiment of the present disclosure.

FIG. 7 is a schematic diagram illustrating spatial positions of corner points and projection points corresponding to each calibration plate after optimizing an external parameter according to an embodiment of the present disclosure.

FIG. 8 is a schematic structural diagram illustrating a calibration apparatus according to an embodiment of the present disclosure.

FIG. 9 is a schematic structural diagram illustrating a calibration device according to an embodiment of the present disclosure.

The specific examples of the present disclosure have been illustrated through the above drawings and will be described in more detail below. These drawings and text description are not intended to limit the scope of the conception of the present disclosure in any way, but to explain the concept of the present disclosure for those skilled in the art by referring to the specific examples.

### DETAILED DESCRIPTION

Exemplary embodiments will be described in detail here with the examples thereof expressed in the drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

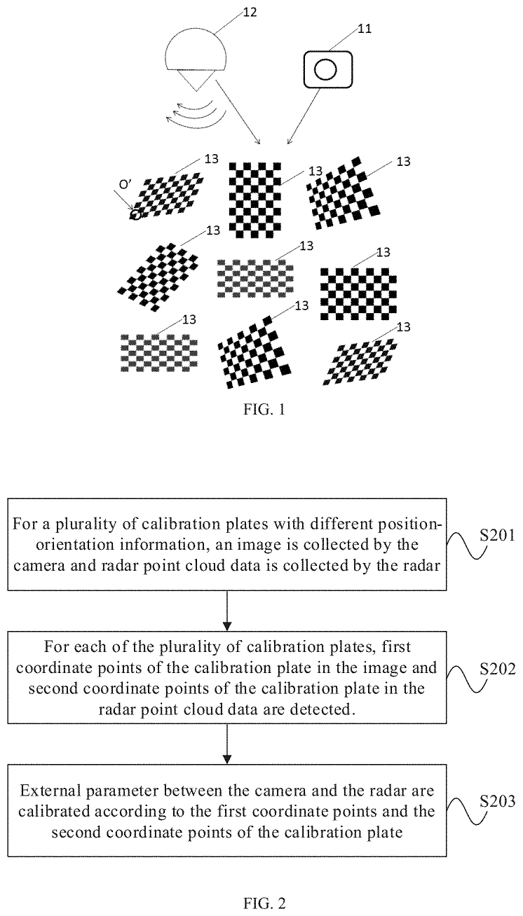

A calibration method for a sensor provided by an embodiment of the present disclosure can be applied to a calibration system shown in FIG. 1. As shown in FIG. 1, the calibration system includes a camera 11, a radar 12 and a plurality of calibration plates 13. The camera 11 may be a monocular camera, a binocular camera or a camera with more cameras. The radar 12 may be a radar commonly used in automobiles such as a lidar and a millimeter wave radar. Patterns of the plurality of calibration plates 13 usually include distinctive features, such as checkerboards, feature point sets and feature edges, and the shapes of the calibration plates 13 may be regular graphics such as rectangular graphic and circular graphic, or irregular graphics.

In addition, before using the camera 11 to formally capture images or using the radar 12 to formally scan, all the calibration plates 13 can be observed in advance by the camera 11 or scanned in advance by the radar 12, and positions or orientations of some or all of the calibration plates 13 can be adjusted, or position or orientation of the sensor can be adjusted, so that all the calibration plates 13 are located within a common Field Of View (FOV) range of the camera 11 and the radar 12 at the same time and are completely visible, and cover the FOV range of the camera 11 and the radar 12 as much as possible, especially an edge portion of an image taken by the camera or an edge portion of a region scanned by the radar.

A FOV of the camera refers to a region that can be seen through the camera, and the FOV range of the camera refers to a range corresponding to a region where the image can be collected by the camera. In the embodiment of the present disclosure, the FOV range of the camera can be determined based on one or a combination of the following parameters; a distance from a camera lens to an object to be captured, a size of the camera, a focal length of the camera lens, and the like. For example, if the distance from the camera lens to the object is 1500 mm, the size of the camera is 4.8 mm and the focal length of the camera lens is 50 mm, then the FOV of the camera is (1500*4.8)/50=144 mm. In an implementation, the visual field range of the camera can also be understood as a Field Of View (FOV) of the camera, that is, an angle formed from a center point of the camera lens to both diagonal of an imaging plane. For the same imaging area, the shorter the focal length of the camera lens, the larger the FOV of the camera.

The FOV of the radar refers to a region that can be scanned by the radar, and the FOV range of the radar refers to a range corresponding to a region where radar point cloud data can be scanned by the radar, including a vertical FOV range and a horizontal FOV range. The vertical FOV range refers to a range corresponding to a region where the radar point cloud data can be scanned by the radar in a vertical direction, and the horizontal FOV range refers to a range corresponding to a region where the radar point cloud data can be scanned by the radar in a horizontal direction. Taking a rotating lidar as an example, the rotating lidar has a horizontal FOV of 360 degrees and a vertical FOV of 40 degrees, which means that the rotating lidar can scan a region within 360 degrees in the horizontal direction and a region within 40 degrees in the vertical direction. It should be noted that angle values corresponding to the horizontal FOV and the vertical FOV of the above-mentioned rotating lidar are only an exemplary expression, and are not intended to limit the embodiment of the present disclosure.

In addition, in this embodiment, it is also expected that all calibration plates 13 are not covered by each other or not covered by other objects. When the plurality of calibration plates 13 are not covered by each other, it can be understood that there is no overlap between the plurality of calibration plates 13 within a common FOV range of the camera, and each of the plurality of calibration plates 13 is complete. That is, there is no overlap between the plurality of calibration plates 13 represented in the captured image and the scanned radar point cloud data, and the plurality of calibration plates 13 are all complete. Therefore, in a process of arranging the plurality of calibration plates 13, any two calibration plates 13 are separated by a certain distance, instead of being closely next to each other. In the process of arranging the plurality of calibration plates 13, at least two of the plurality of calibration plates 13 may have different horizontal distances to the camera 11 or the radar 12, so that position information of the plurality of calibration plates 13 represented by the image collected by the camera 11 and the radar point cloud data scanned by the radar 12 is more diversified. Taking the camera 11 as an example, it means that reflections of the plurality of calibration plates 13 within various distance ranges from the camera 11 are involved in a single collected image. For example, the FOV range of the camera 11 is divided into three dimensions, which are a short distance, a moderate distance, and a long distance from the camera 11, respectively. In this way, at least the reflections of the calibration plates 13 within the above three dimensions are involved in the single collected image, so that the position information of the calibration plates 13 represented in the collected image is diversified. In the process of arranging the plurality of calibration plates 13, at least two of the plurality of calibration plates 13 may have different horizontal distances to the radar 12, which is similar to the camera 11, the detailed description may refer to the part of the camera and will not be repeated herein.

In addition, it can achieve to make the calibration plates 13 represented in the collected image or radar point cloud data clearer by ensuring the calibration plates 13 flat. For example, by fixing the periphery of the calibration plate 13 through a position limiting device such as an aluminum alloy frame, characteristic data such as graphics and point sets presented on the calibration plate 13 are clearer.

It should be noted that the number of the calibration plates 13 in FIG. 1 is only illustrative, and should not be understood as limiting on the number of the calibration plates 13. Those skilled in the art can arrange a corresponding number of calibration plates 13 according to actual conditions.

The calibration system shown in FIG. 1 in the embodiment of the present disclosure can be used to calibrate external parameters of multiple sensors such as the camera and the radar. It should be noted that the calibration system shown in FIG. 1 can be used to calibrate a vehicle-mounted camera and a vehicle-mounted radar in an automatic driving scenario, a robot equipped with a vision system, or an unmanned aerial vehicle (UAV) equipped with multiple sensors, and the like. In the embodiment of the present disclosure, the technical solution of the present disclosure is described by taking the calibration of the external parameter between a camera and a radar.

It should be noted that in a process of calibrating multiple sensors, one or more of internal parameters and external parameters of the sensors can be calibrated. When the sensor includes a camera and a radar, the process of calibrating the sensor can be to calibrate one or more of internal parameters of the camera, external parameters of the camera, internal parameters of the radar, external parameters of the radar, and external parameters between the camera and the radar.

The internal parameter refers to a parameter related to characteristics of the sensor itself, which can include factory parameters of the sensor, such as performance parameters and technical parameters of the sensor. The external parameter refers to a parameter of a position relationship of the objects relative to the sensor in a world coordinate system, and may include parameters used to represent a conversion relationship from a certain point in a space to a sensor coordinate system.

The internal parameter of the camera refers to a parameter related to characteristics of the camera itself, and may include but not limited to one or a combination of the following parameters; a focal length of the camera and a resolution of the image.

The external parameter of the camera refer to a parameter of a position relationship of the objects relative to the camera in the world coordinate system, and may include but not limited to one or a combination of the following parameters: distortion parameters of the images collected by the camera, parameters used to represent a conversion relationship from a certain point in the space to a camera coordinate system.

The internal parameter of the radar refers to a parameter related to characteristics of the radar itself. Taking the lidar as an example, the internal parameter may include but not limited to one or a combination of the following parameters: wavelength, detection distance, field of view and ranging accuracy. For an optical instrument, the field of view refers to an angle which is bounded by taking a lens of the optical instrument as the vertex and taking two edges of a maximum range as two lines, where an object image of a measured object in the maximum range can pass through the lens. A size of the field of view determines the FOV range of the optical instrument. The larger the field of view, the larger the FOV, and the smaller the optical magnification.

The external parameter of the radar refers to a parameter of a position relationship of objects relative to the radar in the world coordinate system, and may include but not limited to one or a combination of the following parameters: parameters used to represent a conversion relationship from a certain point in the space to a radar coordinate system.

The external parameter between the camera and the radar refer to parameters of a position relationship of objects in a physical world in the camera coordinate system relative to the radar coordinate system.

It should be noted that above description of the internal parameter and the external parameter are only an example, and are not used to limit the internal parameter of the camera, the external parameter of the camera, the internal parameter of the radar, the external parameter of the radar, and the external parameter between the camera and the radar.

The calibration method for a sensor provided by the embodiment of the present disclosure aims to solve the technical problems in the related art.

In the following, technical solutions of the present disclosure and how the technical solutions of the present disclosure solve the above technical problems will be described in detail through specific embodiments by taking the lidar as an example. The following several specific embodiments can be combined with each other, and the identical or similar concepts or procedures may not be repeated in some embodiments. The embodiments of the present disclosure will be described with reference to the drawings.

FIG. 2 is a flowchart illustrating a calibration method for a sensor according to an embodiment of the present disclosure. The embodiment of the present disclosure provides a calibration method for a sensor aiming at the technical problems in the related art, wherein the sensor includes a camera and a radar. The method includes the following steps.

Step 201, for a plurality of calibration plates with different position-orientation information, an image is collected by the camera and radar point cloud data is collected by the radar.

The plurality of calibration plates are located within a common Field Of View (FOV) range of the camera and the radar. The image collected by the camera and the radar point cloud data collected by the radar include representations of the plurality of calibration plates, respectively, and the plurality of calibration plates are not covered by each other and have different position-orientation information.

The above-mentioned position-orientation information refers to a position state of the calibration plate in the space, and may specifically include position information and orientation information. The position information refers to a relative positional relationship of the calibration plate relative to the camera and the radar, and the orientation information refers to an orientation of the calibration plate on the position indicated by the position information, such as rotation and pitch/elevation. In the embodiment of the present disclosure, the position-orientation information may also refer to information of the calibration plate corresponding to at least one of six dimensions of the space. Therefore, when the position-orientation information is different, it means that the information in at least one dimension of the space is different. The six dimensions refer to shift information and rotation information of the calibration plate separately on X axis, Y axis and Z axis of a three-dimensional coordinate system.

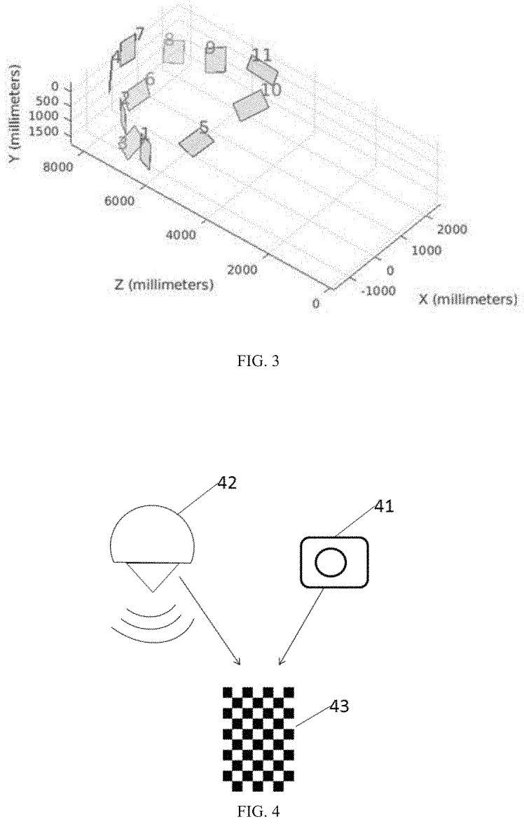

Specifically, as shown in FIG. 1, a scenario containing the plurality of calibration plates 13 is captured by the camera 11 to obtain the plurality of calibration plates 13 with different positions and orientations in a camera coordinate system. The positions and orientations of the plurality of calibration plates 13 in the camera coordinate system can be shown in FIG. 3. It can be seen from FIG. 3, the position-orientation information of the plurality of calibration plates 13 in the camera coordinate system is different.

Specifically, as shown in FIG. 1, the scenario containing a plurality of calibration plates 13 is scanned by the radar 12 to obtain a set of radar point cloud data. Optionally, the radar includes a lidar and a laser line emitted by the lidar intersects with respective planes on which each of the plurality of calibration plates 13 is located, so as to obtain laser point cloud data. Taking the lidar as an example, for example, when a laser beam emitted by the lidar irradiates surfaces of the calibration plates 13, the surfaced of the calibration plated 13 will reflect the laser beam. If the laser emitted by the lidar is scanned according to a certain trajectory, such as 360-degree rotating scan, a large number of laser points will be obtained, and thus, radar point cloud data corresponding to the calibration plates 13 can be formed.

The image captured by the camera includes complete reflections of the plurality of calibration plates. If the image in this embodiment includes a plurality of images, the plurality of images can be images collected by the camera, or multiple frames of images which are from a video sequence collected by the camera through recording or the like and may be adjacent in timing or not. If the radar point cloud data in this embodiment includes multiple sets of radar point cloud data, the multiple sets of radar point cloud data can be radar point cloud sequences collected by the radar many times. The radar point cloud sequences include multiple sets of radar point cloud data that are adjacent or not in the time sequence.

It should be noted here that the camera and the radar need to work at the same time to ensure time synchronization of the camera and the radar, and to minimize the influence of a time error of data collected by the camera and the radar on the calibration plate.

Step 202, for each of the plurality of calibration plates, first coordinate points of the calibration plate in the image and second coordinate points of the calibration plate in the radar point cloud data are detected.

The first coordinate points include coordinate points of the plurality of calibration plates in the image, and the second coordinate points include coordinate points of the plurality of calibration plates in the radar point cloud data.

For one of the plurality of calibration plates, the first coordinate points include corner points in the image mapped from lattice points of the calibration plate, and the second coordinate points include points in the radar point cloud data mapped from the lattice points of the calibration plate.

In this embodiment, detecting the first coordinate points of each of the plurality of calibration plates in the image includes: detecting corner points of the plurality of calibration plates in the image respectively. The corner points refer to pixel points in the image mapped from the lattice points of the calibration plates. Generally, a local maximum value in the mage can be regarded as a corner point. For example, if being brighter or darker than its surrounding pixel points, one pixel point can be regarded as the corner point. The pixel points corresponding to the image mapped from the intersection of every two lines of the checkerboard on the calibration plate in FIG. 1 can be detected as the corner points. The lattice point of the calibration plates refers to the intersection of two lines used to divide a black grid and a white grid when the calibration plates have a checkerboard pattern, that is, a vertex of a rectangle on the calibration plates indicating the black grid or the white grid. For example, the lattice point O′ illustrated in FIG. 1 (pointed by the arrow on the left in FIG. 1).

Illustratively, detecting the corner points corresponding to the plurality of calibration plates in the image respectively may mean detecting the corner points corresponding to at least two of the plurality of calibration plates in the image. For example, if there are twenty calibration plates in the calibration system, an image containing reflections of a part or all of the calibration plates may be collected by the camera, for example, an image involving the reflections of eighteen calibration plates. In this way, the corner points corresponding to the eighteen calibration plates in the image can be detected. Of course, it is also possible to detect the corner points corresponding to less than eighteen calibration plates in the image. For example, in the image involving the reflections of eighteen calibration plates, the corner points corresponding to fifteen calibration plates thereof are detected in the image.

In this embodiment, since the radar point cloud data collected by the radar may have irregular density, outliers, noise and other factors, which may lead to a large number of noise points in the point cloud data, it is necessary to preprocess the collected radar point cloud data, such as filtering, to filter out noise points in the radar point cloud data. After the noise points are filtered out, the remaining radar point cloud data is the detected coordinate points of the plurality of calibration plates in the radar point cloud data, that is, the second coordinate points.

Step 203, an external parameter between the camera and the radar are calibrated according to the first coordinate points and the second coordinate points of the calibration plate.

Optionally, calibrating the external parameter between the camera and the radar according to the first coordinate points and the second coordinate points of the calibration plate includes: determining first position-orientation information of the calibration plate in a camera coordinate system according to the first coordinate points of the calibration plate and an internal parameter of the camera; determining second position-orientation information of the calibration plate in a radar coordinate system according to the second coordinate points of the calibration plate: calibrating the external parameter between the camera and the radar according to the first position-orientation information and the second position-orientation information of the calibration plate.

In this embodiment, the internal parameter of the camera can be obtained by pre-calibration based on the existing calibration algorithm, which can be referred to the existing calibration algorithm for the internal parameter of the camera, and this embodiment will not be repeated here.

The first position-orientation information of each calibration plate in the camera coordinate system refers to the position state information of each calibration plate in the camera coordinate system, and may specifically include three-dimensional position coordinate information and orientation information. In an example, the three-dimensional position coordinate information of each calibration plate in the camera coordinate system can be coordinate values on X axis, Y axis and Z axis of the camera coordinate system. The orientation information of each calibration plate in the camera coordinate system can be a roll angle, a pitch angle and a yaw angle of each calibration plate in the camera coordinate system, where the specific definitions of the roll angle, the pitch angle and the yaw angle may be referred to the introduction of the related art, and this embodiment will not be specifically introduced here.

The first coordinate points detected in this step is used to represent a position of each calibration plate in the image, that is, to represent two-dimensional information of the calibration plate. The three-dimensional position information of the calibration plate in the camera coordinate system can be determined based on the calibrated the internal parameter of the camera and the corner points in the two-dimensional image. For example, a Perspective-n-Point (PnP) algorithm may be adopted to determine the three-dimensional position information of each calibration plate in the camera coordinate system, so as to convert a single two-dimensional image from a calibration plate coordinate system to the camera coordinate system.

Specifically. N points on the plurality of calibration plates in the world coordinate system are projected onto the image according to the calibrated internal parameter of the camera and a pending external parameter of the camera, so as to obtain N projection points, an objective function is established according to the N points, the N projection points, the calibrated internal parameter of the camera and the pending external parameter of the camera; an optimal solution of the objective function is found to obtain final external parameter of the camera, that is, parameters for representing a conversion relationship from the calibration plate coordinate system to the camera coordinate system.

Specifically, the second position-orientation information of each calibration plate in the radar coordinate system refers to the position state information of each calibration plate in the radar coordinate system, and may specifically include three-dimensional position coordinate information and orientation information. The three-dimensional position coordinate information of each calibration plate in the radar coordinate system refers to coordinate values on X axis, Y axis and Z axis of the radar coordinate system. The orientation information of each calibration plate in the radar coordinate system refers to a roll angle, a pitch angle and a yaw angle of each calibration plate in the radar coordinate system, where the specific definitions of the roll angle, the pitch angle and the yaw angle may be referred to the introductions of the related arts, and this embodiment will not be specifically introduced here.

The second coordinate points detected in this step is used to represent a position of each calibration plate in the radar point cloud data, that is, a position of each calibration plate in the radar coordinate system. Therefore, the second position-orientation information of each calibration plate in the radar coordinate system can be obtained according to the second coordinate points. With the above implementation, a conversion from the calibration plate coordinate system to the radar coordinate system can be obtained, that is, a plane of each calibration plate in the radar point cloud data is screened out based on plane information in the radar point cloud data, so as to obtain position-orientation information of each calibration plate in the radar coordinate system, that is, the second position-orientation information.

Then, the external parameter between the camera coordinate system and the radar coordinate system are determined according to the first position-orientation information of each calibration plate in the camera coordinate system and the second position-orientation information of each calibration plate in the radar coordinate system. The external parameter between the camera coordinate system and the radar coordinate system refer to parameters such as position and rotation direction of the camera relative to the radar, which can be understood as parameters for representing a conversion relationship between the camera coordinate system and the radar coordinate system. The parameters of the conversion relationship can enable the data collected by the camera and the radar in the same period to be synchronized in space, thereby achieving better fusion of the camera and the radar.

Optionally, in the embodiment of the present disclosure, the external parameter between the camera and the radar can also be calibrated by using a single calibration plate. Illustratively, a calibration system shown in FIG. 4 can be adopted to calibrate the external parameter between the camera and the radar. The calibration system includes a camera 41, a radar 42 and a calibration plate 43. In the process of calibrating the camera and the radar, the calibration plate 43 is moved and/or rotated, or the camera 41 and the radar 42 are moved (in the process of moving, it is necessary to keep the relative position relationship between the camera 41 and the radar 42 unchanged). Further, a plurality of images containing a calibration plate 43 can be captured by the camera 41, the position and the orientation of the calibration plate 43 in each image are different, and multiple sets of radar point cloud data containing a calibration plate 43 can be obtained by scanning with the radar 42. The image collected by the camera 41 and the radar point cloud data scanned by the radar 42 on the calibration plate 43 at the same position and with the same orientation are referred as a set of data. Multiple sets of data, such as 10-20 sets, can be obtained by collecting and scanning many times. Then, data that meets the requirements of calibration algorithm is selected from multiple sets of data as the selected image and radar point cloud data; and then the external parameter between the camera 41 and the radar 42 are calibrated based on the selected image and radar point cloud data.

In a calibration scenario with the plurality of calibration plates, the first coordinate points of each calibration plate in the image and the second coordinate points of each calibration plate in the radar point cloud data are detected based on the image collected by the camera and the radar point cloud data collected by the radar. Then, the external parameter between the camera and the radar are calibrated based on the first coordinate points and the second coordinate points of each calibration plate. The plurality of calibration plates are located within a common Field Of View (FOV) range of the camera and the radar, and have different position-orientation information.

Since the image and the radar point cloud data for calibration are respectively collected by the camera and the radar in such a scenario that a plurality of calibration plates with different position-orientation information are contained, a single image includes reflections of the plurality of calibration plates, and a set of radar point cloud data includes point cloud data of the plurality of calibration plates. Therefore, by collecting an image and a corresponding set of radar point cloud data, the external parameter between the camera and the radar can be calibrated, so that the number of images to be processed and the number of radar point cloud data to be processed can be effectively reduced while ensuring calibration accuracy, thereby saving resources occupied in data processing process.

In addition, in an image collection process of an actual calibration process, since the calibration plates are in a static state throughout the whole process, for the radar and the camera, the requirements for synchronization of the camera and the radar can be effectively reduced, thereby improving the calibration accuracy effectively.

Optionally, for each of the plurality of calibration plates, detecting the first coordinate points of the calibration plate in the image includes: determining candidate corner points corresponding to the calibration plate in the image; clustering the candidate corner points to obtain corner points corresponding to the calibration plate in the image; taking the obtained corner points as the first coordinate points of the calibration plate in the image. The candidate corner points refer to corner points corresponding to the lattice points of the calibration plates. In this embodiment, pixel points belonging to the calibration plates in the image can be obtained by clustering the candidate corner points. The points in the candidate corner points, which do not belong to the calibration plates, can be filtered out via being clustered, thereby de-noising the image. The detailed implementation process may be that, a certain pixel point in the image is taken as a reference point to determine a neighborhood in the image, a similarity between a pixel point in the neighborhood and the current pixel point is calculated, and the pixel point in the neighborhood is regarded as a similar point of the current pixel point if the similarity is less than a preset threshold. Optionally, the similarity may be measured by a sum of squared difference (SSD). In the embodiment of the present disclosure, other similarity calculation approaches may also be adopted for the measure. The preset threshold may be set in advance, and especially, may be adjusted according to the different patterns on the calibration plates. The value of the preset threshold is not limited here.

Optionally, determining the candidate corner points corresponding to the plurality of calibration plates in the image includes: detecting the corner points in the image; preliminarily filtering out points other than the corner points mapped from the lattice points of the calibration plates to the image from the detected corner points, so as to obtain the candidate corner points. The detected corner points include the corner points mapped from the lattice points of the calibration plates to the image, and may also include other misdetected points. Therefore, the candidate corner points can be obtained by filtering out the misdetected points, for example, the misdetected points. Optionally, a non-maximum suppression approach may be adopted to preliminarily filter out the points other than the corner points mapped from the lattice points of the calibration plates to the image. Though this embodiment, other misdetected points in the image can be preliminarily filtered out, so as to achieve preliminary denoising.

Optionally, after obtaining the candidate corner points from the detected corner points via preliminarily filtering out the points, e.g., the misdetected points, other than the corner points mapped from the lattice points of the calibration plates to the image, the method further includes: clustering the candidate corner points in the image to filter out discrete pixel points from the candidate corner points. Through this embodiment, on the basis of the previous denosing, the number of the corner points in the image can be determined based on the number of lattice points on the calibration plate. Moreover, according to the character that the lattice points of the calibration plates are distributed regularly, the pixel points that do not belong to the corner points corresponding to the lattice points on the calibration plates can be filtered out. For example, for a 6*10 calibration plate with 5*9=45 lattice points, there should be 45 corresponding corner points in the image. The above step is to filter out other pixel points than these 45 corner points. Through this embodiment, the corner points that do not belong to the lattice points of the calibration plates can be further filtered out in the image, so as to achieve a further denoising.

Optionally, after the corner points corresponding to the calibration plate in the image are obtained, the method in this embodiment further includes: correcting positions of the clustered corner points in the image based on a straight line constraint relationship of the lattice points from each of the plurality of calibration plates, and taking the corrected corner points as the first coordinate points. In this embodiment, the corner points corresponding to the lattice points on each calibration plate can be obtained after clustering the candidate corner points, but their positions may be inaccurate. For example, for three lattice points in one straight line on the calibration plates, there should be three corresponding corner points in one straight line in the image. As an instance, A(1, 1), B (2, 2) and C (3, 3) should locate in the one straight line in the image. However, for the clustered corner points, there may be one corner point falling out of the straight line, for example, the coordinates of the clustered corner points are A (1, 1), B (2, 2) and C (3.1, 3.3). Therefore, it is required to correct the corner point C to (3, 3), so that the corner point C can line in the same straight line as the other two corner points A and B. Through the correction process of this step, the detected corner points can present more accurate positions, thereby improving the calibration accuracy in the subsequent calibration process.

The above processes are described in detail through a complete example below.

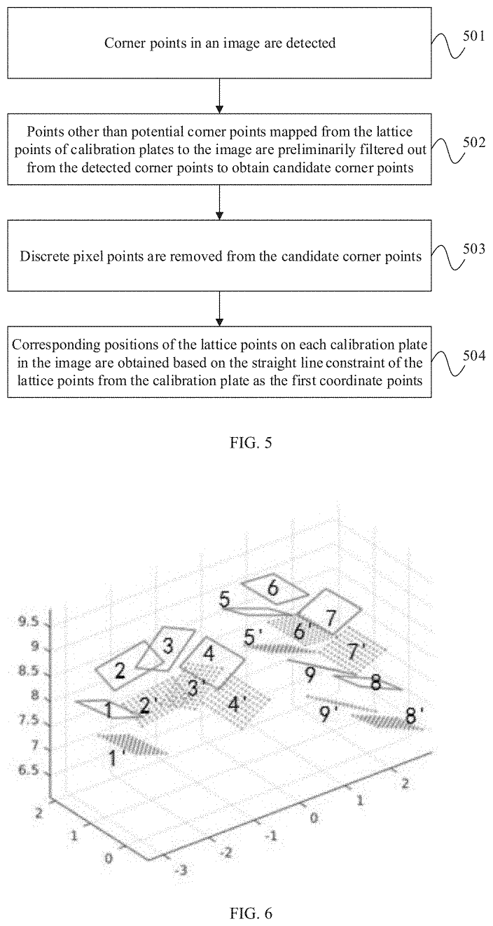

FIG. 5 is a flowchart illustrating a calibration method for a sensor according to another embodiment of the present disclosure. The method includes the following steps.

Step 501, corner points in an image are detected.

The corner points can be detected according to an existing corner point detection algorithm. Optionally, this step may include: finding all possible pixel-level corner points in the image according to the existing corner point detection algorithm, and further refining the corner points to a sub-pixel level based on image gradient information.

Step 502, points, e.g., the misdetected points, other than potential corner points mapped from the lattice points of calibration plates to the image are preliminarily filtered out from the detected corner points to obtain candidate corner points.

It may filter out the points other than the potential corner points mapped from the lattice points of the calibration plates to the image by adopting the non-maximum suppression approach. For example, the non-maximum suppression approach may be adopted to preliminarily filter out the misdetected points.

Step 503, discrete pixel points are removed from the candidate corner points.

Specifically, since the lattice points on the calibration plates are regularly distributed, in this step 503, the candidate corner points can be clustered to remove those discrete pixel points, so as to further filter out the noisy pixel points.

Since the image of this embodiment involves the plurality of calibration plates, the pixel points corresponding to each calibration plate are usually dense, and since there is a certain distance between every two calibration plates, there is a certain interval between the dense pixel point groups corresponding to every two calibration plates. Therefore, through the clustering approach, the position corresponding to each calibration plate can be roughly divided and the discrete points other than the corner points corresponding to the lattice points of the calibration plates can be filtered out.

Since the number of the lattice points on the calibration plates is known, the number of corner points corresponding to the image is usually determined. Therefore, the denoising can be performed in accordance with the relationship that the number of the lattice points of the calibration plates is to the same as the number of the corner points corresponding to the image.

Step 504, the corresponding positions of the lattice points on each calibration plate in the image are obtained based on the straight line constraint of the lattice points from the calibration plate as the first coordinate points.

Optionally, after the corresponding positions of the lattice points on each calibration plate in the image are divided in the step 503, the pixel points in the image, which correspond to the lattice points on each calibration plate, may be treated based on the straight line constraint of the lattice points from the calibration plate, so as to obtain the positions of the corner points corresponding to the lattice points of each calibration plate in the image. The straight line constraint of the lattice points from the calibration plates refers to the relationship that the pixel points corresponding to the lattice points on the calibration plates are distributed on the same straight line.

In an implementation of the embodiment in the present disclosure, for each calibration plate, the positions of the detected corner points are stored in a matrix form. Supposing that the number of the calibration plates is N. N matrices can be obtained through the corner point detection approach provided by this embodiment. For example, there are nine calibration plates in the calibration system illustrated in FIG. 2, and thus for each image, nine matrices can be obtained through the corner point detection approach provided by this embodiment to indicate the positions of the detected corner points.

Optionally, determining the second position-orientation information of each of the plurality of calibration plates in the radar coordinate system according to the second coordinate points includes: determining a plane region in the radar point cloud data on which the calibration plate is located; determining position-orientation information corresponding to the plane region as the second position-orientation information of the calibration plate in the radar coordinate system. Since the three-dimensional points of each calibration plate in the radar point cloud data are dense and obviously different from other regions in the radar point cloud data, the plane matching the shape of the calibration plate can be determined in the radar point cloud data. For example, if the calibration plate is rectangle, the plane region can be determined by determining a rectangular plane formed by coordinate points in the radar point cloud data. After the plane region is determined, position-orientation information corresponding to the plane region can be determined as the second position-orientation information of the calibration plate in the radar coordinate system.

Optionally, if the external parameter between the camera and the radar include a conversion relationship between the camera coordinate system and the radar coordinate system, calibrating the external parameter between the camera and the radar according to the first position-orientation information and the second position-orientation information of the calibration plate includes: for a corner point of each calibration plate in the camera coordinate system, determining a corresponding point of the corner point in the radar coordinate system, and determining the corner point of each calibration plate in the camera coordinate system and the corresponding point in the radar coordinate system as a point pair; determining a pending conversion relationship according to a plurality of point pairs; converting the second coordinate points according to the pending conversion relationship to obtain a third coordinate point in the image; in the case that a distance between the third coordinate point and the first coordinate points corresponding to the third coordinate in the image is less than a threshold, determining the pending conversion relationship as the conversion relationship.

Optionally, for the corner point of each calibration plate in the camera coordinate system, determining the corresponding point of the corner point in the radar coordinate system includes: determining a central position of each calibration plate, and determining a fourth coordinate point of the central position in the camera coordinate system and a fifth coordinate point of the central position in the radar coordinate system; determining a matching relationship of each calibration plate in the camera coordinate system and the radar coordinate system according to a corresponding relationship between the fourth coordinate point in the camera coordinate system and the fifth coordinate point in the radar coordinate system; determining a corresponding point on a position in a region where the matching relationship exists with each calibration plate in the radar coordinate system according to the position of the corner point of the calibration plate in the camera coordinate system.

Of course, in this embodiment, other positions of the calibration plate can also be selected to determine a fourth coordinate point of the positions in the camera coordinate system and a fifth coordinate point of the positions in the radar coordinate system, which is not specifically limited in this embodiment. For example, the other positions can be a position close to a central point of the calibration plate, or a position away from an edge of the calibration plate.

In one embodiment, a set of corner points detected in the camera coordinate system is P(X₁, X₂, . . . Xₙ), and a set of coordinate points detected in the radar coordinate system is G(Y₁, Y₂, . . . Yₙ), where the corner points in the image can be represented by Pᵢ, Pᵢ=Xᵢ. First, a preset constraint condition such as a quatemion matrix (4*4 rotation and shift matrix) is defined, and then the set of corner points P is cross-multiplied by the quatemion matrix to obtain a corresponding set of coordinate points P′(X′₁, X′₂, . . . X′ₙ) in the radar coordinate system. In this way, the corner points Pᵢ in the image corresponding to the coordinate points Pᵢ′ in the radar point cloud data can be obtained, an objective function can be established based on the Pᵢ and Pᵢ′, and a least square error can be calculated for the objective function by using the lease square method, so as to determine whether the error is within a preset error range. If the error is within the preset error range, the iteration is stopped and if the error is not within the preset error range, rotation information and shift information of the quaternion matrix are adjusted according to the error, and the above process is continued to be performed according to the adjusted quaternion matrix until the error is within the preset error range. The final quaternion matrix is taken as a final conversion relationship. The objective function can be established based on Euclidean distance between Pᵢ and Pᵢ′. The above error range can be set in advance, and the value of the error range is not limited in the embodiments of the present disclosure.

Specifically, determining the matching relationship of each calibration plate in the camera coordinate system and the radar coordinate system can be understood as corresponding the calibration plate in the camera coordinate system to the calibration plate in the radar coordinate system, that is, the same calibration plate in the scenario shown in FIG. 1 is found in the camera coordinate system and the radar coordinate system respectively, and a corresponding relationship between the position coordinate of the calibration plate in the camera coordinate system and the position coordinate of the calibration plate in the radar coordinate system is established. For example, the plurality of calibration plates respectively have numbers distinguished by Arabic numerals, as shown in FIG. 6. It is assumed that the numbers of the plurality of calibration plates in the camera coordinate system are 1 to 9 respectively, and the numbers of the plurality of calibration plates in the radar coordinate system are 1′ to 9′ respectively, where he calibration plates numbered 1′ to 9′ in the camera coordinate system sequentially correspond to the calibration plates numbered 1′ to 9′ in the radar coordinate system, for example, the calibration plate No. 1 in the camera coordinate system and the calibration plate No. 1′ in the radar coordinate system correspond to the same calibration plate in the calibration system. Therefore, the matching relationship of the calibration plate in the camera coordinate system and the calibration plate in the radar coordinate system is to find the calibration plate No. 1 in the camera coordinate system and the calibration plate No. 1′ in the radar coordinate system respectively, and establish the corresponding relationship between the position coordinate of the calibration plate No. 1 in the camera coordinate system and the position coordinate of the calibration plate No. 1′ in the radar coordinate system.

Optionally, after the calibration plate in the camera coordinate system corresponds to the calibration plate in the radar coordinate system, a corresponding calibration plate in the calibration system can be determined. Further, the corner points corresponding to the lattice points of the calibration plate in the camera coordinate system and the corresponding points corresponding to the lattice points of the calibration in the radar coordinate system can be arranged in a preset order, for example, sorted by row or column, and then the method steps provided by this embodiment are performed by row or column. However, in general, since it is to match the same calibration plate represented in the image and the radar point cloud data in response to matching the calibration plates involved in the image and the radar point cloud data in the above embodiment and the orientations of the calibration plate may change, it is also required to adjust the orientations of the calibration plate in the image or the radar point cloud data, so that the orientations of the same calibration plate in the image and the radar point cloud data are also the same. The orientation information represented by the calibration plate refers to direction information and/or location information of the calibration plate in the image and the radar point cloud data. Taking the direction information as an example, the calibration plate can be placed in a horizontal state in the image collection process and in a vertical state in the radar point cloud data collection process, where the horizontal and the vertical directions can be the orientation information represented by the calibration plate.

Since the obtained external parameter between the camera and the radar, that is, a transformation matrix T between the camera and the radar, is relatively rough, it is necessary to further optimize the transformation matrix T by nonlinear optimization method, so as to make the external parameter more accurate. Optimizing the external parameter between the camera and the radar may include: establishing an objective function based on the detected corner points and projection points projected in the image from the lattice points on the calibration plates in the radar coordinate system to the image under the radar coordinate system; and seeking an optimal solution to the objective function to obtain the final external parameter between the camera and the radar. Establishing the objective function based on the detected corner points and projection points projected in the image from the lattice points on the calibration plates in the radar coordinate system to the image under the radar coordinate system may include: according to the external parameter between the camera and the radar, the calibrated internal parameter, the coordinates of the corner points in the camera coordinate system, and the conversion relationship between the radar coordinate system and the camera coordinate system, projecting the lattice points on the calibration plates in the radar coordinate system in the image through a projection functional relationship to obtain the projection points; and establishing the objective function based on the detected corner points and the projection points. In this way, an error of each calibration plate in the camera coordinate system and the radar coordinate system can be minimized, the positions of the detected points can be optimized, and the calibration accuracy of the external parameter between the camera and the radar can be improved.

FIG. 6 is a schematic diagram illustrating spatial positions of corner points and projection points corresponding to each calibration plate before optimizing external parameters.

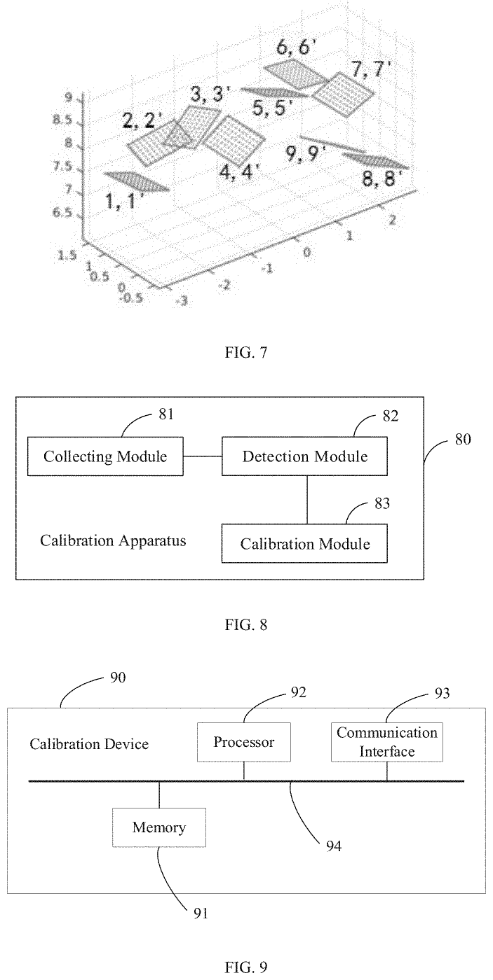

FIG. 7 is a schematic diagram illustrating spatial positions of corner points and projection points corresponding to each calibration plate after optimizing external parameters.

Taking the lidar as an example, as shown in FIGS. 6 and 7, point sets in FIGS. 6 and 7 are projections of the calibration plates in the camera coordinate system obtained by converting the calibration plates in a lidar coordinate system, which are used to represent positions of the calibration plates in the camera coordinate system after the calibration plates in the lidar coordinate system are converted. The solid box in FIGS. 6 and 7 is corner points corresponding to the lattice points of the calibration plates in the camera coordinate system, which is used to represent the calibration plates in the camera coordinate system.

It can be seen from FIG. 6, there is a distance between an original position of the calibration plate in the camera coordinate system and a position of the calibration plate in the camera coordinate system converted from the radar coordinate system. For example, the number of the calibration plate is 1 in the camera coordinate system, and the number of the calibration plate in the camera coordinate system converted from the radar coordinate system is 1′, and thus there is a certain distance between the calibration plate 1 and the calibration plate 1′ in the camera coordinate system. Similarly, there is a distance between the calibration plates 2-9 in the camera coordinate system and the converted calibration plates 2′-9′ in the camera coordinate system respectively.

It can be seen from FIG. 7, the distance between the original position of the same calibration plate in the camera coordinate system and the position in the camera coordinate system converted from the radar coordinate system is reduced after optimization, and the positions of the same calibration plate in the camera coordinate system obtained in the two cases almost coincide.

After the external parameters between the camera and the radar are calibrated through the calibration method of the foregoing embodiments, data collected by the calibrated camera and radar can be used for ranging, positioning or automatic driving control. For example, in the case of using the data collected by the camera and radar with the calibrated external parameters, it may specifically include: collecting an image including a surrounding environment of a vehicle through a calibrated vehicle-mounted camera; collecting radar point cloud data including the surrounding environment of the vehicle through a calibrated vehicle-mounted radar, fusing the image and the radar point cloud data based on the environment information; determining a current location of the vehicle based on the fused data; controlling the vehicle according to the current location, such as controlling the vehicle to slow down, to brake or to take a turning. In the process of ranging, the laser emitted by the lidar is irradiated on the surface of the object and then is reflected by the surface of the object. The lidar can determine the orientation information and the distance information of the object relative to the lidar according to the laser reflected by the surface of the object. Therefore, ranging can be achieved.

For the vehicle-mounted camera, the vehicle-mounted radar and other carriers equipped with the camera and the radar, since the camera and the radar are usually fixed on the carrier, they are inconvenient to move. In the case of adopting the technical solutions provided by the embodiments of the present disclosure, the calibration for multiple sensors can be achieved without moving the camera and the radar.

In addition, for the vehicle-mounted camera, the vehicle-mounted radar, or the unmanned aerial vehicle or the robot equipped with multiple sensors such as the camera and the radar, since surrounding environment information often affects the safety of the automatic driving or flying and robot walking, its collection is very important for the automatic driving of the vehicle or the flight of the unmanned aerial vehicles and path planning of the robot. Through the calibration method of this embodiment to calibrate, the calibration accuracy can be improved, so that an accuracy of the surrounding environment information for data processing is also higher. Correspondingly, for other functions of the vehicle or the unmanned aerial vehicle such as a positioning function and a ranging function, the accuracy will also be improved, thereby improving the safety of the unmanned driving or flying. For the robot, the increase in the calibration accuracy can improve an accuracy of various operations performed by the robot based on its vision system.

In addition, in order to simplify the calibration process, objects with regular graphics or easily identifiable information, such as road signs and traffic signs, can also be utilized to calibrate at least one of the camera and the radar deployed on the vehicle. In the embodiment of the present disclosure, the conventional calibration plates are adopted to describe the calibration process of the external parameters between the camera and the radar, however, it is not limited to using the conventional calibration plates to achieve the calibration process. Specifically, the sensor calibration can be correspondingly implemented based on the characteristics or limitations of the object on which the sensor is deployed.

FIG. 8 is a schematic structural diagram illustrating a calibration apparatus for a sensor according to an embodiment of the present disclosure. The calibration apparatus provided by the embodiment of the present disclosure can perform the processing flow provided by the embodiment of the calibration method for the sensor. The sensor includes a camera and a radar, a plurality of calibration plates are located within a common Field Of View (FOV) range of the camera and the radar, and have different position-orientation information. As shown in FIG. 8, the calibration apparatus 80 includes a collecting module 81, a detection module 82 and a calibration module 83. The collecting module 81 is configured to, for the plurality of calibration plates with different position-orientation information, collect an image by the camera and collect radar point cloud data by the radar. The detection module 82 is configured to, for each of the plurality of calibration plates, detect first coordinate points of the calibration plate in the image and second coordinate points in the radar point cloud data. The calibration module 83 is configured to calibrate an external parameter between the camera and the radar according to the first coordinate points and the second coordinate points of the calibration plate.

Optionally, calibrating, by the calibration module 83, the external parameter between the camera and the radar according to the first coordinate points and the second coordinate points of the calibration plate further includes: determining first position-orientation information of each of a plurality of calibration plates in a camera coordinate system according to the first coordinate points and an internal parameter of the camera; determining second position-orientation information of each of the plurality of calibration plates in a radar coordinate system according to the second coordinate points; calibrating the external parameter between the camera and the radar according to the first position-orientation information and the second position-orientation information of the calibration plate.

Optionally, detecting, by the detection module 82, the first coordinate points of the calibration plate in the image further includes: determining candidate corner points corresponding to the calibration plate in the image: clustering the candidate corner points to obtain corner points corresponding to the calibration plate in the image; taking the obtained corner points as the first coordinate points of the calibration plate in the image.

Optionally, after the corner points corresponding to the calibration plate in the image are obtained, the detection module 82 is further configured to correct positions of the clustered corner points in the image according to a straight line constraint relationship of three or more lattice points on the calibration plate; and take the corrected corner points as the first coordinate points of the calibration plate in the image.

Optionally, determining, by the calibration module 83, the second position-orientation information of the calibration plate in the radar coordinate system according to the second coordinate points further includes: determining a plane region in the radar point cloud data on which the calibration plate is located; and determining position-orientation information corresponding to the plane region as the second position-orientation information of the calibration plate in the radar coordinate system.

Optionally, the external parameter between the camera and the radar include a conversion relationship between the camera coordinate system and the radar coordinate system; calibrating, by the calibration module 83, the external parameter between the camera and the radar according to the first position-orientation information and the second position-orientation information of the calibration plate further includes: for each corner point of the calibration plate in the camera coordinate system, determining a corresponding point of the corner point in the radar coordinate system, and determining the corner point of the calibration plate in the camera coordinate system and the corresponding point of the calibration plate in the radar coordinate system as a point pair; determining a pending conversion relationship according to a plurality of point pairs; converting the second coordinate points according to the pending conversion relationship to obtain a third coordinate point in the image; in the case that a distance between the third coordinate point and the first coordinate points corresponding to the third coordinate in the image is less than a threshold, determining the pending conversion relationship as the conversion relationship.

Optionally, for each corner point of the calibration plate in the camera coordinate system, determining, by the calibration module 83, the corresponding point of the corner point in the radar coordinate system further includes: determining a central position of the calibration plate, and determining a fourth coordinate point of the central position in the camera coordinate system and a fifth coordinate point in the radar coordinate system; determining a matching relationship of the calibration plate in the camera coordinate system and the radar coordinate system according to a corresponding relationship between the fourth coordinate point in the camera coordinate system and the fifth coordinate point in the radar coordinate system; determining a corresponding point on a position in a region where the matching relationship exists with the calibration plate in the radar coordinate system according to the position of the corner point of the calibration plate in the camera coordinate system.

Optionally, a pattern of the calibration plate includes at least one of a feature point set and a feature edge.

Optionally, the radar and the camera are deployed on a vehicle.

Optionally, the image includes complete reflections of the plurality of calibration plates, and the radar point cloud data includes complete point cloud data corresponding to the plurality of calibration plates.

Optionally, at least one calibration plate of the plurality of calibration plates is located at an edge position of a FOV of the camera.

Optionally, the radar includes a lidar, and a laser line emitted by the lidar intersects with respective planes on which each of the plurality of calibration plates is located.

Optionally, there is no overlapping region among the plurality of calibration plates in the FOV of the camera or the FOV of the radar.

Optionally, horizontal distances from at least two of the calibration plates of the plurality of calibration plates to the camera or the radar are different.

The calibration apparatus of the embodiment shown in FIG. 8 can be used to perform the technical solution of the above method embodiment, the implementation principle and technical effect of which are similar, and will not be repeated herein.

FIG. 9 is a schematic structural diagram illustrating a calibration device according to an embodiment of the present disclosure. The calibration device provided by the embodiment of the present disclosure can perform the processing flow provided by the embodiment of the calibration method for the sensor, wherein the sensor includes a camera and a radar, a plurality of calibration plates are located within a common Field Of View (FOV) range of the camera and the radar, and have different position-orientation information. As shown in FIG. 9, the calibration device 90 includes a memory 91, a processor 92, a computer program, a communication interface 93, and a bus 94, where the computer program is stored in the memory 91 and configured to be executed by the processor 92 to implement the following method steps: for a plurality of calibration plates with different position-orientation information, collecting an image by a camera, and collecting radar point cloud data by a radar; for each of the plurality of calibration plates, detecting first coordinate points of the calibration plate in the image and second coordinate points of the calibration plate in the radar point cloud data; calibrating an external parameter between the camera and the radar according to the first coordinate points and the second coordinate points of the calibration plate.

Optionally, calibrating, by the processor 92, the external parameter between the camera and the radar according to the first coordinate points and the second coordinate points of the calibration plate further includes: determining first position-orientation information of each of a plurality of calibration plates in a camera coordinate system according to the first coordinate points and an internal parameter of the camera; determining second position-orientation information of each of the plurality of calibration plates in a radar coordinate system according to the second coordinate points; calibrating the external parameter between the camera and the radar according to the first position-orientation information and the second position-orientation information of the calibration plate.

Optionally, detecting, by the processor 92, the first coordinate points of the calibration plate in the image further includes: determining candidate corner points corresponding to the calibration plate in the image; clustering the candidate corner points to obtain corner points corresponding to the calibration plate in the image, taking the obtained corner points as the first coordinate points of the calibration plate in the image.

Optionally, the processor 92 is further configured to correct positions of the clustered corner points in the image according to a straight line constraint relationship of three or more lattice points on the calibration plate, and take the corrected corner points as the first coordinate points of the calibration plate in the image.

Optionally, determining, by the processor 92, the second position-orientation information of the calibration plate in the radar coordinate system according to the second coordinate points further includes: determining a plane region in the radar point cloud data on which the calibration plate is located: and determining position-orientation information corresponding to the plane region as the second position-orientation information of the calibration plate in the radar coordinate system.

Optionally, the external parameter between the camera and the radar include a conversion relationship between the camera coordinate system and the radar coordinate system; calibrating, by the processor 92, the external parameter between the camera and the radar according to the first position-orientation information and the second position-orientation information of the calibration plate further includes: for each corner point of the calibration plate in the camera coordinate system, determining a corresponding point of the corner point in the radar coordinate system, and determining the corner point of the calibration plate in the camera coordinate system and the corresponding point of the calibration plate in the radar coordinate system as a point pair; determining a pending conversion relationship according to a plurality of point pairs; converting the second coordinate points according to the pending conversion relationship to obtain a third coordinate point in the image; in the case that a distance between the third coordinate point and the first coordinate points corresponding to the third coordinate in the image is less than a threshold, determining the pending conversion relationship as the conversion relationship.

Optionally, for each corner point of the calibration plate in the camera coordinate system, determining, by the processor 92, the corresponding point of the corner point in the radar coordinate system further includes: determining a central position of the calibration plate, and determining a fourth coordinate point of the central position in the camera coordinate system and a fifth coordinate point in the radar coordinate system; determining a matching relationship of the calibration plate in the camera coordinate system and the radar coordinate system according to a corresponding relationship between the fourth coordinate point in the camera coordinate system and the fifth coordinate point in the radar coordinate system; determining a corresponding point on a position in a region where the matching relationship exists with the calibration plate in the radar coordinate system according to the position of the corner point of the calibration plate in the camera coordinate system.

Optionally, a pattern of the calibration plate includes at least one of a feature point set and a feature edge.

Optionally, the radar and the camera are deployed on a vehicle.

Optionally, the image includes complete reflections of the plurality of calibration plates, and the radar point cloud data includes complete point cloud data corresponding to the plurality of calibration plates.

Optionally, the radar includes a lidar, and a laser line emitted by the lidar intersects with respective planes on which each of the plurality of calibration plates is located.

Optionally, there is no overlapping region among the plurality of calibration plates in a FOV of the camera or the FOV of the radar.

Optionally, at least one calibration plate of the plurality of calibration plates is located at an edge position of the FOV of the camera or the FOV of the radar.

Optionally, horizontal distances from at least two calibration plates of the plurality of calibration plates to the camera or the radar are different.

The calibration device of the embodiment shown in FIG. 9 can be used to perform the technical solution of the above method embodiment, the implementation principle and technical effect of which are similar, and will not be repeated herein.

In addition, the embodiment of the present disclosure further provides a computer readable storage medium, on which a computer program is stored, and the computer program is executed by a processor to implement the calibration method for a sensor in the above embodiments.

In several embodiments provided by the present disclosure, it should be understood that the disclosed apparatus and method can be implemented in other ways. For example, the apparatus embodiment described above is only schematic, such as the division of the unit is only a logical function division, and there may be another division manner in an actual implementation, for example, multiple units or components can be combined or integrated into another system, or some features can be ignored or not implemented. On the other hand, a mutual coupling or a direct coupling or a communication connection shown or discussed herein can be an indirect coupling or the communication connection through some interfaces, apparatuses or units, and it can be electric, mechanical or other forms.

The unit illustrated as a separation part may or may not be physically separated, and the component displayed as the unit may or may not be a physical unit, that is, it may be located in one place, or it may be distributed to multiple network units. Some or all of the units can be selected according to the actual requirement to achieve the purpose of the embodiment.

In addition, each functional unit in respective embodiment of the present disclosure can be integrated in one processing unit or can be physically exist independently, or two or more units can be integrated in one unit. The above integrated units can be implemented either in the form of hardware or in the form of hardware plus a software functional unit.

The integrated unit implemented in the form of the software functional unit can be stored in the computer readable storage medium. The software functional unit is stored in a storage medium, including several instructions to enable a computer device (which can be a personal computer, a server, a network device, etc.) or a processor to perform part of the steps of the method of the embodiments of the present disclosure. The aforementioned storage medium includes: a USB disk, a mobile hard disk, a read-only memory (ROM), a random access memory (RAM), a magnetic disk or an optical disk and other medium that can store program codes.

It can be clearly understood by those skilled in the art that, for the convenience and simplicity of description, only the division of the above functional modules is illustrated as examples. In practical application, the above functional allocation can be completed by different functional modules according to actual requirements, that is, an internal structure of the apparatus can be divided into different functional modules to complete all or part of above functions. A specific working process of the above apparatus can refer to the corresponding process in the aforementioned method embodiment, and will not be repeated herein.

Finally, it should be noted that the above respective embodiment is only used to explain the technical solution of the present disclosure, not to limit it; although the disclosure has been described in detail with reference to the above embodiment, those skilled in the art should understand that they can still modify the technical solution recorded in the above respective embodiment, or equivalent replace some or all of the technical features. These modifications or replacements do not separate the essence of the corresponding technical solution from the scope of the technical solution of the respective embodiment of the present disclosure.

1. A calibration method for a sensor, comprising:
obtaining an image acquired by a camera of the sensor and obtaining radar point cloud data acquired by a radar of the sensor, wherein a plurality of calibration plates are located within a common Field Of View (FOV) range of the camera and the radar, and have different position-orientation information;
for each of the plurality of calibration plates, detecting first coordinate points of the calibration plate in the image and second coordinate points of the calibration plate in the radar point cloud data; and
calibrating an external parameter between the camera and the radar according to the first coordinate points and the second coordinate points of each of the plurality of calibration plates.

2. The calibration method according to claim 1, wherein detecting the first coordinate points of the calibration plate in the image comprises:
determining candidate corner points corresponding to the calibration plate in the image; and
clustering the candidate corner points to obtain clustered corner points corresponding to the calibration plate in the image;
wherein the first coordinate points of the calibration plate in the image are detected based on the corner points corresponding to the calibration plate in the image.

3. The calibration method according to claim 2, wherein, after the corner points corresponding to the calibration plate in the image are obtained, the calibration method further comprises:
correcting positions of the clustered corner points in the image according to a straight line constraint relationship of three or more lattice points on the calibration plate; and
determining the corner points with the corrected positions to be the first coordinate points of the calibration plate in the image.

4. The calibration method according to claim 1, wherein calibrating the external parameter between the camera and the radar according to the first coordinate points and the second coordinate points of each of the plurality of calibration plates comprises:
for each of the plurality of calibration plates,
determining first position-orientation information of the calibration plate in a camera coordinate system according to the first coordinate points of the calibration plate and an internal parameter of the camera;
determining second position-orientation information of the calibration plate in a radar coordinate system according to the second coordinate points of the calibration plate; and
calibrating the external parameter between the camera and the radar according to the first position-orientation information and the second position-orientation information of the calibration plate.

5. The calibration method according to claim 4, wherein determining the second position-orientation information of the calibration plate in the radar coordinate system according to the second coordinate points of the calibration plate comprises:
determining a plane region in the radar point cloud data on which the calibration plate is located; and
determining position-orientation information corresponding to the plane region as the second position-orientation information of the calibration plate in the radar coordinate system.

6. The calibration method according to claim 4, wherein the external parameter between the camera and the radar comprises a conversion relationship between the camera coordinate system and the radar coordinate system, and
wherein calibrating the external parameter between the camera and the radar according to the first position-orientation information and the second position-orientation information of the calibration plate comprises:
for each corner point of the calibration plate in the camera coordinate system, determining a corresponding point of the corner point in the radar coordinate system and forming a point pair including the corner point and the corresponding point of the corner point;
determining a pending conversion relationship according to a plurality of point pairs corresponding to the calibration plate;
converting the second coordinate points according to the pending conversion relationship to obtain third coordinate points in the image; and
in response to determining that a distance between the third coordinate points and the first coordinate points corresponding to the third coordinate points in the image is less than a threshold, determining the pending conversion relationship as the conversion relationship.

7. The calibration method according to claim 6, wherein, for each corner point of the calibration plate in the camera coordinate system, determining the corresponding point of the corner point in the radar coordinate system comprises:
determining a central position of the calibration plate, and determining a fourth coordinate point of the central position in the camera coordinate system and a fifth coordinate point of the central position in the radar coordinate system;
determining a matching relationship of the calibration plate in the camera coordinate system and the radar coordinate system according to a corresponding relationship between the fourth coordinate point in the camera coordinate system and the fifth coordinate point in the radar coordinate system; and
according to a position of the corner point of the calibration plate in the camera coordinate system, determining a position of the corresponding point of the corner point in the radar coordinate system in a region where the matching relationship exists with the calibration plate.

8. The calibration method according to claim 1, wherein a pattern of the calibration plate comprises at least one of a feature point set and a feature edge.

9. The calibration method according to claim 1, wherein the radar and the camera are deployed on a vehicle.

10. The calibration method according to claim 1, wherein the image comprises complete reflections of the plurality of calibration plates, and the radar point cloud data comprises complete point cloud data corresponding to the plurality of calibration plates.

11. The calibration method according to claim 1, wherein the radar comprises a lidar, and a laser line emitted by the lidar intersects with respective planes on which each of the plurality of calibration plates is located.

12. The calibration method according to claim 1, wherein the plurality of calibration plates are configured to have at least one of:
no overlapping region in a FOV of the camera or a FOV of the radar,
at least one of the plurality of calibration plates located at an edge position of the FOV of the camera or the FOV of the radar, or
different horizontal distances from at least two of the plurality of calibration plates to the camera or the radar.

13. A calibration device for a sensor, comprising:
at least one processor; and
at least one non-transitory memory coupled to the at least one processor and storing programming instructions for execution by the at least one processor to perform operations comprising:
obtaining an image acquired by a camera of the sensor and obtaining radar point cloud data acquired by a radar of the sensor, wherein a plurality of calibration plates are located within a common Field Of View (FOV) range of the camera and the radar, and have different position-orientation information;
for each of the plurality of calibration plates, detecting first coordinate points of the calibration plate in the image and second coordinate points of the calibration plate in the radar point cloud data; and
calibrating an external parameter between the camera and the radar according to the first coordinate points and the second coordinate points of each of the plurality of calibration plates.

14. The calibration device according to claim 13, wherein detecting the first coordinate points of the calibration plate in the image comprises:
determining candidate corner points corresponding to the calibration plate in the image; and
clustering the candidate corner points to obtain clustered corner points corresponding to the calibration plate in the image,
wherein the first coordinate points of the calibration plate in the image are detected based on the corner points corresponding to the calibration plate in the image.

15. The calibration device according to claim 14, wherein, after the corner points corresponding to the calibration plate in the image are obtained, the operations further comprise:
correcting positions of the corner points in the image according to a straight line constraint relationship of three or more lattice points on the calibration plate; and
determining the corner points with the corrected positions to be the first coordinate points of the calibration plate in the image.

16. The calibration device according to claim 13, wherein calibrating the external parameter between the camera and the radar according to the first coordinate points and the second coordinate points of each of the plurality of calibration plates comprises:
for each of the plurality of calibration plates,
determining first position-orientation information of the calibration plate in a camera coordinate system according to the first coordinate points of the calibration plate and an internal parameter of the camera;
determining second position-orientation information of the calibration plate in a radar coordinate system according to the second coordinate points of the calibration plate; and
calibrating the external parameter between the camera and the radar according to the first position-orientation information and the second position-orientation information of the calibration plate.

17. The calibration device according to claim 16, wherein determining the second position-orientation information of the calibration plate in the radar coordinate system according to the second coordinate points of the calibration plate comprises:
determining a plane region in the radar point cloud data in which the calibration plate is located; and
determining position-orientation information corresponding to the plane region as the second position-orientation information of the calibration plate in the radar coordinate system.

18. The calibration device according to claim 16, wherein the external parameter between the camera and the radar comprises a conversion relationship between the camera coordinate system and the radar coordinate system, and
wherein calibrating the external parameter between the camera and the radar according to the first position-orientation information and the second position-orientation information of the calibration plate comprises:
for each corner point of the calibration plate in the camera coordinate system, determining a corresponding point of the corner point in the radar coordinate system and forming a point pair including the corner point and the corresponding point of the corner point;
determining a pending conversion relationship according to a plurality of point pairs corresponding to the calibration plate;
converting the second coordinate points according to the pending conversion relationship to obtain third coordinate points in the image; and
in response to determining that a distance between the third coordinate points and the first coordinate points corresponding to the third coordinate points in the image is less than a threshold, determining the pending conversion relationship as the conversion relationship.

19. The calibration device according to claim 18, wherein, for each corner point of the calibration plate in the camera coordinate system, determining the corresponding point of the corner point in the radar coordinate system comprises:
determining a central position of the calibration plate, and determining a fourth coordinate point of the central position in the camera coordinate system and a fifth coordinate point of the central position in the radar coordinate system;
determining a matching relationship of the calibration plate in the camera coordinate system and the radar coordinate system according to a corresponding relationship between the fourth coordinate point in the camera coordinate system and the fifth coordinate point in the radar coordinate system; and
according to a position of the corner point of the calibration plate in the camera coordinate system, determining a position of the corresponding point of the corner point in the radar coordinate system in a region where the matching relationship exists with the calibration plate.

20. A system comprising:
a sensor including a camera and a radar;
a plurality of calibration plates located within a common Field Of View (FOV) range of the camera and the radar, wherein the plurality of calibration plates have different position-orientation information; and
a calibration device for calibrating the sensor, the calibration device comprising:
at least one processor; and
at least one non-transitory memory coupled to the at least one processor and storing programming instructions for execution by the at least one processor to:
obtain an image acquired by the camera of the sensor and obtain radar point cloud data acquired by the radar of the sensor;
for each of the plurality of calibration plates, detect first coordinate points of the calibration plate in the image and second coordinate points of the calibration plate in the radar point cloud data; and
calibrate an external parameter between the camera and the radar according to the first coordinate points and the second coordinate points of each of the plurality of calibration plates.
